(19) United States
(12) Patent Application Publication
(10) Pub. No.: US 2004/0108509 A1
(43) Pub. Date: Jun. 10, 2004

(54) Light emitting molecules and organic light emitting devices including light emitting molecules

(76) Inventor: Gabriel Joseph Caballero, Longmont, CO (US)

Correspondence Address: S. A. Sullivan, Greenlee, Winner and Sullivan, P.C., 5370 Manhattan Circle, Suite 201, Boulder, CO, 80303, US

(21) Appl. No.: 10/654,586

(22) Filed: Sep. 2, 2003

Related U.S. Application Data
(60) Provisional application No. 60/407,813, filed on Sep. 3, 2002.

(51) Int. Cl. H05B 33/14; C09K 11/06

(52) U.S. Cl. 257/88; 313/504; 428/690; 428/917

(57) ABSTRACT

Light emitting molecules and organic light emitting devices including such light emitting molecules are described. In one embodiment, a light emitting molecule includes an anchoring group and a charge transport group having a first end and a second end. The first end of the charge transport group is bonded to the anchoring group. The charge transport group is configured to provide transport of electrical energy, and the transport of electrical energy is substantially one-dimensional. The light emitting molecule also includes a light emissive group bonded to the second end of the charge transport group and a charge transfer group bonded to the light emissive group.

### CROSS-REFERENCE TO RELATED APPLICATION

This application claims the benefit of U.S. Provisional Application Serial No. 60/407,813, filed on Sep. 3, 2002, the disclosure of which is incorporated herein by reference in its entirety.

### FIELD OF THE INVENTION

The invention relates to organic light emitting devices. For example, light emitting molecules and organic light emitting devices including such light emitting molecules are described.

### BACKGROUND OF THE INVENTION

Organic light emitting devices have begun to attract great interest for a number of applications. For example, attempts have been made to incorporate organic light emitting devices in display devices. Organic light emitting devices can potentially offer a number of advantages over other types of display technologies. In particular, compared with certain types of display technologies, organic light emitting devices have the potential to offer lower manufacturing costs, reduced energy requirements, and improved visual characteristics.

However, existing organic light emitting devices often suffer from a number of problems. Existing organic light emitting devices are typically formed by depositing multiple organic layers on a substrate. The requirement of multiple organic layers can result in added weight and additional manufacturing costs. Also, the organic layers are sometimes formed from amorphous or randomly oriented polymeric materials. As a result of such random orientation, electrical conductivity of the organic layers can be inadequate, and charged species can travel relatively great distances along the randomly oriented polymeric materials before reaching a fluorescent or phosphorescent species that can emit light. At the same time, such random orientation can lead to the formation of “micro-wells” that can act as capacitors to further lower the electrical conductivity of the organic layers. To produce light having a desired brightness, a greater electric field density is sometimes applied to the organic layers, which electric field density can lead to thermal breakdown or instability of the organic layers.

It is against this background that a need arose to develop the light emitting molecules and organic light emitting devices described herein.

### SUMMARY OF THE INVENTION

In one innovative aspect, the invention relates to a light emitting molecule. In one embodiment, the light emitting molecule includes an anchoring group and a charge transport group having a first end and a second end. The first end of the charge transport group is bonded to the anchoring group. The charge transport group is configured to provide transport of electrical energy, and the transport of electrical energy is substantially one-dimensional. The light emitting molecule also includes a light emissive group bonded to the second end of the charge transport group and a charge transfer group bonded to the light emissive group.

In another innovative aspect, the invention relates to a pixel element. In one embodiment, the pixel element includes a light emitting molecule. The light emitting molecule includes an anchoring group and a conjugated group extending from the anchoring group and having a first end bonded to the anchoring group and an opposite, second end. The conjugated group has a formula (A-B)ₘ-A, m being an integer in the range of 1 to 19, A being an arylene group, B being one of an alkenylene group, an alkynylene group, and an iminylene group. The light emitting molecule also includes a light emissive group bonded to the second end of the conjugated group.

In yet another innovative aspect, the invention relates to an organic light emitting device. In one embodiment, the organic light emitting device includes a set of pixel elements arranged in an array. At least one pixel element of the set of pixel elements includes a light emitting molecule that includes an anchoring group configured to bond the light emitting molecule to a first conductive layer. The light emitting molecule also includes a charge transport group having a first end, a second end, and a longitudinal axis. The first end of the charge transport group is bonded to the anchoring group. The charge transport group is configured to provide transport of electrical energy substantially along the longitudinal axis. The light emitting molecule further includes a light emissive group bonded to the second end of the charge transport group and a charge transfer group bonded to the light emissive group and configured to bond the light emitting molecule to a second conductive layer.

In a further innovative aspect, the invention relates to a display device. In one embodiment, the display device includes an anode layer, a cathode layer, and a set of pixel elements arranged in an array and positioned between the anode layer and the cathode layer. At least one pixel element of the set of pixel elements includes a light emitting molecule that includes an anchoring group bonded to the anode layer. The light emitting molecule also includes a charge transport group having a first end and a second end. The first end of the charge transport group is bonded to the anchoring group. The light emitting molecule further includes a light emissive group bonded to the second end of the charge transport group and a charge transfer group bonded to the light emissive group and to the cathode layer.

In another embodiment, the display device includes a first conductive layer, a second conductive layer, and a set of light emitting molecules positioned between the first conductive layer and the second conductive layer. The set of light emitting molecules are substantially aligned with respect to a common direction. At least one light emitting molecule of the set of light emitting molecules includes an anchoring group bonded to the first conductive layer, a conjugated group extending from the anchoring group and having a first end bonded to the anchoring group and an opposite, second end, and a light emissive group bonded to the second end of the conjugated group.

### BRIEF DESCRIPTION OF THE DRAWINGS

For a better understanding of the nature and objects of various embodiments of the invention, reference should be made to the following detailed description taken in conjunction with the accompanying drawings.

FIG. 1 illustrates a side sectional view of an organic light emitting device according to an embodiment of the invention.

FIG. 2 illustrates a pixel element according to an embodiment of the invention.

FIG. 3 illustrates a top sectional view of an organic light emitting device according to an embodiment of the invention.

FIG. 4 and FIG. 5 illustrate a method of forming an organic light emitting device using a self-assembled monolayer process, according to an embodiment of the invention.

FIG. 6, FIG. 7, and FIG. 8 illustrate an example of forming an organic light emitting device using a self-assembled monolayer process, according to an embodiment of the invention.

### DETAILED DESCRIPTION

### Overview

Embodiments of the invention relate to organic light emitting devices. In particular, various embodiments of the invention relate to light emitting molecules and organic light emitting devices including such light emitting molecules. Organic light emitting devices in accordance with various embodiments of the invention can offer a number of advantages, such as, for example, improved transport of electrical energy, improved robustness and thermal stability, improved visual characteristics, reduced energy requirements, and reduced weight.

Organic light emitting devices in accordance with various embodiments of the invention can include a set of light emitting molecules arranged in an array and positioned between two conductive layers. In some instances, the set of light emitting molecules can be substantially aligned with respect to a common direction, and each light emitting molecule of the set of light emitting molecules can extend between the two conductive layers. A light emitting molecule can include a charge transport group and a light emissive group bonded to the charge transport group. The charge transport group can be configured to provide transport of electrical energy to the light emissive group. In some instances, the transport of electrical energy can be substantially one-dimensional, such as, for example, along a longitudinal axis of the charge transport group. In response to the transport of electrical energy, the light emissive group can be configured to emit light having a desired wavelength or range of wavelengths.

### Definitions

The following definitions apply to some of the elements described with regard to some embodiments of the invention. These definitions may likewise be expanded upon herein.

The term “set” refers to a collection of one or more elements. Elements of a set can also be referred to as members of the set. Elements of a set can be the same or different. In some instances, elements of a set can share one or more common characteristics.

The term “bond” and its grammatical variations refer to a coupling or joining of two or more elements. In some instances, a bond can refer to a coupling of two or more atoms based on an attractive interaction, such that these atoms can form a stable structure. Examples of bonds include chemical bonds such as chemisorptive bonds, covalent bonds, ionic bonds, van der Waals bonds, and hydrogen bonds. The term “intermolecular bond” refers to a chemical bond between two or more atoms that form different molecules, while the term “intramolecular bond” refers to a chemical bond between two or more atoms that form a single molecule, such as, for example, a chemical bond between two groups of the single molecule. Typically, an intramolecular bond includes one or more covalent bonds, such as, for example, σ-bonds, π-bonds, and coordination bonds. The term “conjugated π-bond” refers to a π-bond that has a π-orbital overlapping (e.g., substantially overlapping) a π-orbital of an adjacent π-bond. Additional examples of bonds include various mechanical, physical, and electrical couplings.

The term “group” refers to a set of atoms that form a portion of a molecule. In some instances, a group can include two or more atoms that are bonded to one another to form a portion of a molecule. A group can be monovalent or polyvalent (e.g., bivalent) to allow bonding to one or more additional groups of a molecule. For example, a monovalent group can be envisioned as a molecule with one of its hydrogen atoms removed to allow bonding to another group of a molecule. A group can be positively or negatively charged. For example, a positively charged group can be envisioned as a neutral group with one or more protons (i.e., H+) added, and a negatively charged group can be envisioned as a neutral group with one or more protons removed. Examples of groups include alkyl groups, alkylene groups, alkenyl groups, alkenylene groups, alkynyl groups, alkynylene groups, aryl groups, arylene groups, iminyl groups, iminylene groups, hydride groups, halo groups, hydroxy groups, alkoxy groups, carboxy groups, thio groups, alkylthio groups, disulfide groups, cyano groups, nitro groups, amino groups, alkylamino groups, dialkylamino groups, silyl groups, and siloxy groups.

The term “conjugated group” refers to a group that includes a set of conjugated π-bonds. Typically, a set of conjugated π-bonds can extend through at least a portion of a length of a conjugated group. In some instances, a set of conjugated π-bonds can substantially extend through a length of a conjugated group. In other instances, a set of conjugated π-bonds can include one or more non-conjugated portions, such as, for example, one or more portions lacking substantial overlapping of π-orbitals. Examples of groups that can be used to form a conjugated group include alkylene groups, alkenylene groups, alkynylene groups, arylene groups, and iminylene groups. A conjugated group can be formed from a single group that includes a set of conjugated π-bonds. Alternatively, a conjugated group can be formed from multiple groups that are bonded to one another to provide a set of conjugated π-bonds. A conjugated group can be formed from multiple groups that can be the same or different.

For example, a conjugated group can be formed from n arylene groups, where n is an integer that can be, for example, in the range of 2 to 20. The n arylene groups can be bonded to one another to form a chain structure, and the n arylene groups can include a single type of arylene group or multiple types of arylene groups. In some instances, each arylene group can be independently selected from lower arylene groups, upper arylene groups, monocyclic arylene groups, polycyclic arylene groups, heteroarylene groups, substituted arylene groups, and unsubstituted arylene groups. Each successive pair of arylene groups of the chain structure can be bonded to one another via a group that can be independently selected from alkenylene groups, alkynylene groups, and iminylene groups. For example, the conjugated group can be formed from n−1 alkenylene groups, and the n−1 alkenylene groups can include a single type of alkenylene group or multiple types of alkenylene groups. In some instances, each alkenylene group can be bonded to two successive arylene groups of the chain structure and can be independently selected from lower alkenylene groups, upper alkenylene groups, cycloalkenylene groups, heteroalkenylene groups, substituted alkenylene groups, and unsubstituted alkenylene groups. As another example, the conjugated group can be formed from n−1 alkynylene groups that can be the same or different, and each alkynylene group can be bonded to two successive arylene groups of the chain structure. As a further example, the conjugated group can be formed from n−1 iminylene groups that can be the same or different, and each iminylene group can be bonded to two successive arylene groups of the chain structure.

The term “electron accepting group” refers to a group that has a tendency to attract an electron from another group of the same or a different molecule. The term “electron donating group” refers to a group that has a tendency to provide an electron to another group of the same or a different molecule. For example, an electron accepting group can have a tendency to attract an electron from an electron donating group that is bonded to the electron accepting group. It should be recognized that electron accepting and electron providing characteristics of a group are relative. In particular, a group that serves as an electron accepting group in one molecule can serve as an electron donating group in another molecule. Examples of electron accepting groups include positively charged groups and groups including atoms with relatively high electronegativities, such as, for example, halo groups, hydroxy groups, cyano groups, and nitro groups. Examples of electron donating groups include negatively charged groups and groups including atoms with relatively low electronegativities, such as, for example, alkyl groups.

The term “alkane” refers to a saturated hydrocarbon molecule. For certain applications, an alkane can include from 1 to 100 carbon atoms. The term “lower alkane” refers to an alkane that includes from 1 to 20 carbon atoms, such as, for example, from 1 to 10 carbon atoms, while the term “upper alkane” refers to an alkane that includes more than 20 carbon atoms, such as, for example, from 21 to 100 carbon atoms. The term “branched alkane” refers to an alkane that includes one or more branches, while the term “unbranched alkane” refers to an alkane that is straight-chained. The term “cycloalkane” refers to an alkane that includes one or more ring structures. The term “heteroalkane” refers to an alkane that has one or more of its carbon atoms replaced by one or more heteroatoms, such as, for example, N, Si, S, O, and P. The term “substituted alkane” refers to an alkane that has one or more of its hydrogen atoms replaced by one or more substituent groups, such as, for example, halo groups, hydroxy groups, alkoxy groups, carboxy groups, thio groups, alkylthio groups, cyano groups, nitro groups, amino groups, alkylamino groups, dialkylamino groups, silyl groups, and siloxy groups, while the term “unsubstituted alkane” refers to an alkane that lacks such substituent groups. Combinations of the above terms can be used to refer to an alkane having a combination of characteristics. For example, the term “branched lower alkane” can be used to refer to an alkane that includes from 1 to 20 carbon atoms and one or more branches. Examples of alkanes include methane, ethane, propane, cyclopropane, butane, 2-methylpropane, cyclobutane, and charged, hetero, or substituted forms thereof.

The term “alkyl group” refers to a monovalent form of an alkane. For example, an alkyl group can be envisioned as an alkane with one of its hydrogen atoms removed to allow bonding to another group of a molecule. The term “lower alkyl group” refers to a monovalent form of a lower alkane, while the term “upper alkyl group” refers to a monovalent form of an upper alkane. The term “branched alkyl group” refers to a monovalent form of a branched alkane, while the term “unbranched alkyl group” refers to a monovalent form of an unbranched alkane. The term “cycloalkyl group” refers to a monovalent form of a cycloalkane, and the term “heteroalkyl group” refers to a monovalent form of a heteroalkane. The term “substituted alkyl group” refers to a monovalent form of a substituted alkane, while the term “unsubstituted alkyl group” refers to a monovalent form of an unsubstituted alkane. Examples of alkyl groups include methyl, ethyl, n-propyl, isopropyl, cyclopropyl, butyl, isobutyl, t-butyl, cyclobutyl, and charged, hetero, or substituted forms thereof.

The term “alkylene group” refers to a bivalent form of an alkane. For example, an alkylene group can be envisioned as an alkane with two of its hydrogen atoms removed to allow bonding to one or more additional groups of a molecule. The term “lower alkylene group” refers to a bivalent form of a lower alkane, while the term “upper alkylene group” refers to a bivalent form of an upper alkane. The term “branched alkylene group” refers to a bivalent form of a branched alkane, while the term “unbranched alkylene group” refers to a bivalent form of an unbranched alkane. The term “cycloalkylene group” refers to a bivalent form of a cycloalkane, and the term “heteroalkylene group” refers to a bivalent form of a heteroalkane. The term “substituted alkylene group” refers to a bivalent form of a substituted alkane, while the term “unsubstituted alkylene group” refers to a bivalent form of an unsubstituted alkane. Examples of alkylene groups include methylene, ethylene, propylene, 2-methylpropylene, and charged, hetero, or substituted forms thereof.

The term “alkene” refers to an unsaturated hydrocarbon molecule that includes one or more carbon-carbon double bonds. For certain applications, an alkene can include from 2 to 100 carbon atoms. The term “lower alkene” refers to an alkene that includes from 2 to 20 carbon atoms, such as, for example, from 2 to 10 carbon atoms, while the term “upper alkene” refers to an alkene that includes more than 20 carbon atoms, such as, for example, from 21 to 100 carbon atoms. The term “cycloalkene” refers to an alkene that includes one or more ring structures. The term “heteroalkene” refers to an alkene that has one or more of its carbon atoms replaced by one or more heteroatoms, such as, for example, N, Si, S, O, and P. The term “substituted alkene” refers to an alkene that has one or more of its hydrogen atoms replaced by one or more substituent groups, such as, for example, alkyl groups, halo groups, hydroxy groups, alkoxy groups, carboxy groups, thio groups, alkylthio groups, cyano groups, nitro groups, amino groups, alkylamino groups, dialkylamino groups, silyl groups, and siloxy groups, while the term “unsubstituted alkene” refers to an alkene that lacks such substituent groups. Combinations of the above terms can be used to refer to an alkene having a combination of characteristics. For example, the term “substituted lower alkene” can be used to refer to an alkene that includes from 1 to 20 carbon atoms and one or more substituent groups. Examples of alkenes include ethene, propene, cyclopropene, 1-butene, trans-2 butene, cis-2-butene, 1,3-butadiene, 2-methylpropene, cyclobutene, and charged, hetero, or substituted forms thereof.

The term “alkenyl group” refers to a monovalent form of an alkene. For example, an alkenyl group can be envisioned as an alkene with one of its hydrogen atoms removed to allow bonding to another group of a molecule. The term “lower alkenyl group” refers to a monovalent form of a lower alkene, while the term “upper alkenyl group” refers to a monovalent form of an upper alkene. The term “cycloalkenyl group” refers to a monovalent form of a cycloalkene, and the term “heteroalkenyl group” refers to a monovalent form of a heteroalkene. The term “substituted alkenyl group” refers to a monovalent form of a substituted alkene, while the term “unsubstituted alkenyl group” refers to a monovalent form of an unsubstituted alkene. Examples of alkenyl groups include ethenyl, propenyl, isopropenyl, cyclopropenyl, butenyl, isobutenyl, t-butenyl, cyclobutenyl, and charged, hetero, or substituted forms thereof.

The term “alkenylene group” refers to a bivalent form of an alkene. For example, an alkenylene group can be envisioned as an alkene with two of its hydrogen atoms removed to allow bonding to one or more additional groups of a molecule. The term “lower alkenylene group” refers to a bivalent form of a lower alkene, while the term “upper alkenylene group” refers to a bivalent form of an upper alkene. The term “cycloalkenylene group” refers to a bivalent form of a cycloalkene, and the term “heteroalkenylene group” refers to a bivalent form of a heteroalkene. The term “substituted alkenylene group” refers to a bivalent form of a substituted alkene, while the term “unsubstituted alkenylene group” refers to a bivalent form of an unsubstituted alkene. Examples of alkenyl groups include ethenylene, propenylene, 2-methylpropenylene, and charged, hetero, or substituted forms thereof.

The term “alkyne” refers to an unsaturated hydrocarbon molecule that includes one or more carbon-carbon triple bonds. In some instances, an alkyne can also include one or more carbon-carbon double bonds. For certain applications, an alkyne can include from 1 to 100 carbon atoms. The term “lower alkyne” refers to an alkyne that includes from 2 to 20 carbon atoms, such as, for example, from 2 to 10 carbon atoms, while the term “upper alkyne” refers to an alkyne that includes more than 20 carbon atoms, such as, for example, from 21 to 100 carbon atoms. The term “cycloalkyne” refers to an alkyne that includes one or more ring structures. The term “heteroalkyne” refers to an alkyne that has one or more of its carbon atoms replaced by one or more heteroatoms, such as, for example, N, Si, S, O, and P. The term “substituted alkyne” refers to an alkyne that has one or more of its hydrogen atoms replaced by one or more substituent groups, such as, for example, alkyl groups, alkenyl groups, halo groups, hydroxy groups, alkoxy groups, carboxy groups, thio groups, alkylthio groups, cyano groups, nitro groups, amino groups, alkylamino groups, dialkylamino groups, silyl groups, and siloxy groups, while the term “unsubstituted alkyne” refers to an alkyne that lacks such substituent groups. Combinations of the above terms can be used to refer to an alkyne having a combination of characteristics. For example, the term “substituted lower alkyne” can be used to refer to an alkyne that includes from 1 to 20 carbon atoms and one or more substituent groups. Examples of alkynes include ethyne (i.e., acetylene), propyne, 1-butyne, 1-buten-3-yne, 1-pentyne, 2-pentyne, 3-penten-1-yne, 1-penten-4-yne, 3-methyl-1-butyne, and charged, hetero, or substituted forms thereof.

The term “alkynyl group” refers to a monovalent form of an alkyne. For example, an alkynyl group can be envisioned as an alkyne with one of its hydrogen atoms removed to allow bonding to another group of a molecule. The term “lower alkynyl group” refers to a monovalent form of a lower alkyne, while the term “upper alkynyl group” refers to a monovalent form of an upper alkyne. The term “cycloalkynyl group” refers to a monovalent form of a cycloalkyne, and the term “heteroalkynyl group” refers to a monovalent form of a heteroalkyne. The term “substituted alkynyl group” refers to a monovalent form of a substituted alkyne, while the term “unsubstituted alkynyl group” refers to a monovalent form of an unsubstituted alkyne. Examples of alkynyl groups include ethynyl, propynyl, isopropynyl, butynyl, isobutynyl, t-butynyl, and charged, hetero, or substituted forms thereof.

The term “alkynylene group” refers to a bivalent form of an alkyne. For example, an alkynylene group can be envisioned as an alkyne with two of its hydrogen atoms removed to allow bonding to one or more additional groups of a molecule. The term “lower alkynylene group” refers to a bivalent form of a lower alkyne, while the term “upper alkynylene group” refers to a bivalent form of an upper alkyne. The term “cycloalkynylene group” refers to a bivalent form of a cycloalkyne, and the term “heteroalkynylene group” refers to a bivalent form of a heteroalkyne. The term “substituted alkynylene group” refers to a bivalent form of a substituted alkyne, while the term “unsubstituted alkynylene group” refers to a bivalent form of an unsubstituted alkyne. Examples of alkynylene groups include ethynylene, propynylene, 1-butynylene, 1-buten-3-ynylene, and charged, hetero, or substituted forms thereof.

The term “arene” refers to an aromatic hydrocarbon molecule. For certain applications, an arene can include from 5 to 100 carbon atoms. The term “lower arene” refers to an arene that includes from 5 to 20 carbon atoms, such as, for example, from 5 to 14 carbon atoms, while the term “upper arene” refers to an arene that includes more than 20 carbon atoms, such as, for example, from 21 to 100 carbon atoms. The term “monocyclic arene” refers to an arene that includes a single aromatic ring structure, while the term “polycyclic arene” refers to an arene that includes more than one aromatic ring structure, such as, for example, two or more aromatic ring structures that are bonded via a carbon-carbon single bond or that are fused together. The term “heteroarene” refers to an arene that has one or more of its carbon atoms replaced by one or more heteroatoms, such as, for example, N, Si, S, O, and P. The term “substituted arene” refers to an arene that has one or more of its hydrogen atoms replaced by one or more substituent groups, such as, for example, alkyl groups, alkenyl groups, alkynyl groups, iminyl groups, halo groups, hydroxy groups, alkoxy groups, carboxy groups, thio groups, alkylthio groups, cyano groups, nitro groups, amino groups, alkylamino groups, dialkylamino groups, silyl groups, and siloxy groups, while the term “unsubstituted arene” refers to an arene that lacks such substituent groups. Combinations of the above terms can be used to refer to an arene having a combination of characteristics. For example, the term “monocyclic lower alkene” can be used to refer to an arene that includes from 5 to 20 carbon atoms and a single aromatic ring structure. Examples of arenes include benzene, biphenyl, naphthalene, pyridine, pyridazine, pyrimidine, pyrazine, quinoline, isoquinoline, and charged, hetero, or substituted forms thereof.

The term “aryl group” refers to a monovalent form of an arene. For example, an aryl group can be envisioned as an arene with one of its hydrogen atoms removed to allow bonding to another group of a molecule. The term “lower aryl group” refers to a monovalent form of a lower arene, while the term “upper aryl group” refers to a monovalent form of an upper arene. The term “monocyclic aryl group” refers to a monovalent form of a monocyclic arene, while the term “polycyclic aryl group” refers to a monovalent form of a polycyclic arene. The term “heteroaryl group” refers to a monovalent form of a heteroarene. The term “substituted aryl group” refers to a monovalent form of a substituted arene, while the term “unsubstituted arene group” refers to a monovalent form of an unsubstituted arene. Examples of aryl groups include phenyl, biphenylyl, naphthyl, pyridinyl, pyridazinyl, pyrimidinyl, pyrazinyl, quinolyl, isoquinolyl, and charged, hetero, or substituted forms thereof.

The term “arylene group” refers to a bivalent form of an arene. For example, an arylene group can be envisioned as an arene with two of its hydrogen atoms removed to allow bonding to one or more additional groups of a molecule. The term “lower arylene group” refers to a bivalent form of a lower arene, while the term “upper arylene group” refers to a bivalent form of an upper arene. The term “monocyclic arylene group” refers to a bivalent form of a monocyclic arene, while the term “polycyclic arylene group” refers to a bivalent form of a polycyclic arene. The term “heteroarylene group” refers to a bivalent form of a heteroarene. The term “substituted arylene group” refers to a bivalent form of a substituted arene, while the term “unsubstituted arylene group” refers to a bivalent form of an unsubstituted arene. Examples of arylene groups include phenylene, biphenylylene, naphthylene, pyridinylene, pyridazinylene, pyrirnidinylene, pyrazinylene, quinolylene, isoquinolylene, and charged, hetero, or substituted forms thereof.

The term “imine” refers to a molecule that includes one or more carbon-nitrogen double bonds. For certain applications, an imine can include from 1 to 100 carbon atoms. The term “lower imine” refers to an imine that includes from 1 to 20 carbon atoms, such as, for example, from 1 to 10 carbon atoms, while the term “upper imine” refers to an imine that includes more than 20 carbon atoms, such as, for example, from 21 to 100 carbon atoms. The term “cycloimine” refers to an imine that includes one or more ring structures. The term “heteroimine” refers to an imine that has one or more of its carbon atoms replaced by one or more heteroatoms, such as, for example, N, Si, S, O, and P. The term “substituted imine” refers to an imine that has one or more of its hydrogen atoms replaced by one or more substituent groups, such as, for example, alkyl groups, alkenyl groups, alkynyl groups, halo groups, hydroxy groups, alkoxy groups, carboxy groups, thio groups, alkylthio groups, cyano groups, nitro groups, amino groups, alkylamino groups, dialkylamino groups, silyl groups, and siloxy groups, while the term “unsubstituted imine” refers to an imine that lacks such substituent groups. Combinations of the above terms can be used to refer to an imine having a combination of characteristics. For example, the term “substituted lower imine” can be used to refer to an imine that includes from 1 to 20 carbon atoms and one or more substituent groups. Examples of imines include R^{a}CH═NR^{b}, where R^{a} and R^{b} are independently selected from hydride groups, alkyl groups, alkenyl groups, and alkynyl groups.

The term “iminyl group” refers to a monovalent form of an imine. For example, an iminyl group can be envisioned as an imine with one of its hydrogen atoms removed to allow bonding to another group of a molecule. The term “lower iminyl group” refers to a monovalent form of a lower imine, while the term “upper iminyl group” refers to a monovalent form of an upper imine. The term “cycloiminyl group” refers to a monovalent form of a cycloimine, and the term “heteroiminyl group” refers to a monovalent form of a heteroimine. The term “substituted iminyl group” refers to a monovalent form of a substituted imine, while the term “unsubstituted iminyl group” refers to a monovalent form of an unsubstituted imine. Examples of iminyl groups include —R^{c}CH═NR^{d}, R^{e}CH═NR^{f}—, —CH═NR^{g}, and R^{h}CH═N—, where R^{c} and R^{f} are independently selected from alkylene groups, alkenylene groups, and alkynylene groups, and R^{d}, R^{e}, R^{g}, and R^{h} are independently selected from hydride groups, halo groups, alkyl groups, alkenyl groups, and alkynyl groups.

The term “iminylene group” refers to a bivalent form of an imine. For example, an iminylene group can be envisioned as an imine with two of its hydrogen atoms removed to allow bonding to one or more additional groups of a molecule. The term “lower iminylene group” refers to a bivalent form of a lower imine, while the term “upper iminylene group” refers to a bivalent form of an upper imine. The term “cycloiminylene group” refers to a bivalent form of a cycloimine, and the term “heteroiminylene group” refers to a bivalent form of a heteroimine. The term “substituted iminylene group” refers to a bivalent form of a substituted imine, while the term “unsubstituted iminylene group” refers to a bivalent form of an unsubstituted imine. Examples of iminylene groups include —RⁱCH—NR^{j}—, —CH═NR^{k}—, —R^{l}CH═N—, and —CH═N—, where Rⁱ, R^{j}, R^{k}, and R^{l} are independently selected from alkylene groups, alkenylene groups, and alkynylene groups.

The term “hydride group” refers to —H.

The term “halo group” refers to —X, where X is a halogen atom. Examples of halo groups include fluoro, chloro, bromo, and iodo.

The term “hydroxy group” refers to —OH.

The term “alkoxy group” refers to —OR^{m}, where R^{m} is an alkyl group. Examples of alkoxy groups include methoxy, ethoxy, propoxy, isopropoxy, and charged, hetero, or substituted forms thereof.

The term “carboxy group” refers to —COOH.

The term “thio group” refers to —SH.

The term “alkylthio group” refers to a —SRⁿ, where Rⁿ is an alkyl group. Examples of alkylthio groups include methylthio, ethylthio, propylthio, isopropylthio, and charged, hetero, or substituted forms thereof.

The term “disulfide group” refers to —S—S—.

The term “cyano group” refers to —CN.

The term “nitro group” refers to —NO₂.

The term “amino group” refers to —NH₂.

The term “alkylamino group” refers to —NHR^{o}, where R^{o} is an alkyl group. Examples of alkylamino groups include methylamino, ethylamino, propylamino, isopropylamino, and charged, hetero, or substituted forms thereof.

The term “dialkylamino group” refers to —NR^{p}R^{q}, where R^{p} and R^{q} are independently selected from alkyl groups. Examples of dialkylamino groups include dimethylamino, methylethylamino, diethylamino, dipropylamino, and charged, hetero, or substituted forms thereof.

The term “silyl group” refers to —SiR^{r}R^{s}R^{t}, where R^{r}, R^{s}, and R^{t} are independently selected from a number of groups, such as, for example, hydride groups, halo groups, alkyl groups, alkenyl groups, and alkynyl groups. Examples of silyl groups include trimethylsilyl, dimethylethylsilyl, diethylmethylsilyl, triethylsilyl, and charged, hetero, or substituted forms thereof.

The term “siloxy group” refers to −—O—SiR^{u}R^{v}R^{w}, where R^{u}, R^{v}, and R^{w} are independently selected from a number of groups, such as, for example, hydride groups, halo groups, alkyl groups, alkenyl groups, and alkynyl groups. Examples of siloxy groups include trimethylsiloxy, dimethylethylsiloxy, diethylmethylsiloxy, triethylsiloxy, and charged, hetero, or substituted forms thereof.

The term “luminescer” refers to a set of atoms configured to emit light in response to an energy excitation. In some instances, a luminescer can form a portion of a molecule. A luminescer can emit light in accordance with a number of mechanisms, such as, for example, chemiluminescence, electroluminescence, photoluminescence, and combinations thereof. For example, a luminescer can exhibit photoluminescence in accordance with an absorption-energy transfer-emission mechanism, fluorescence, or phosphorescence. In some instances, a luminescer can be selected based on a desired wavelength or range of wavelengths of light emitted by the luminescer. Examples of luminescers include organic fluorescers, semiconductor nanocrystals, and metal atoms. Thus, for certain applications, a luminescer can include a metal atom, such as, for example, a transition metal atom or a lanthanide metal atom. Examples of transition metals atoms include Cd, Cu, Co, Pd, Zn, Fe, Ru, Rh, Os, Re, Pt, Sc, Ti, V, Cr, Mn, Ni, Mo, Tc, W, La, and Ir. Examples of lanthanide metal atoms include Sm, Eu, Gd, Dy, Th, Tm, Yb, and Lu. Typically, a metal atom that serves as a luminescer is positively charged and is provided in the form of a metal ion. In particular, lanthanide metal atoms typically carry a 3+ charge and can be provided in the form of lanthanide metal ions, such as, for example, Eu³⁺, Dy³⁺, and Tb³⁺.

The term “ligand” refers to a set of atoms configured to bond to a target. In some instances, a ligand can form a portion of a molecule. A ligand can be configured to bond to a luminescer to form a ligand-luminescer complex. A ligand can include a set of coordination atoms to allow bonding to a luminescer. Examples of coordination atoms that can form coordination bonds with a luminescer include N, C, Si, S, O, and P. In some instances, the number and type of coordination atoms can depend on a particular luminescer to be bonded. For certain applications, the number and type of coordination atoms can be selected based on a coordination number of a metal ion. For example, when a metal ion has a coordination number of 9, a ligand can include up to 9 coordination atoms to allow bonding to the metal ion. A ligand can be monocyclic (i.e., include a single ring structure) or polycyclic (i.e., include more than one ring structure). In some instances, a ligand can encage a luminescer within a cavity or other bonding site formed by the ligand. Examples of ligands include crown ethers such as 12-crown-4,15-crown-5,18-crown-6, and 4,13-diaza-18-crown-6, polycyclic ligands such as 4,7,13,16,21-pentaoxa-1,10-diaza bicyclo [8,8,5] heneicosane, and monovalent or polyvalent forms thereof.

The term “conductive layer” refers to a structure formed from an electrically conductive material. Examples of electrically conductive materials include metals, such as copper, silver, gold, platinum, palladium, and aluminum; metal oxides, such as platinum oxide, palladium oxide, aluminum oxide, magnesium oxide, titanium oxide, tin oxide, indium tin oxide, molybdenum oxide, tungsten oxide, and ruthenium oxide; and electrically conductive polymeric materials. For certain applications, an electrically conductive material can be deposited on or otherwise applied to a substrate to form a conductive layer. For example, an electrically conductive material can be deposited on a glass substrate or a silicon wafer to form a conductive layer. In some instances, a conductive layer can have a substantially uniform thickness and a substantially flat outer surface. In other instances, a conductive layer can have a variable thickness and a curved, stepped, or jagged outer surface. A conductive layer can be configured as an anode layer or a cathode layer. For certain applications, a conductive layer can be substantially transparent or translucent. For example, a conductive layer can be formed from an electrically conductive material that is substantially transparent or translucent, such as, for example, magnesium oxide, indium tin oxide, or an electrically conductive polymeric material. As another example, a conductive layer can be formed with a thickness that allows light to be visible through the conductive layer.

### Organic Light Emitting Devices

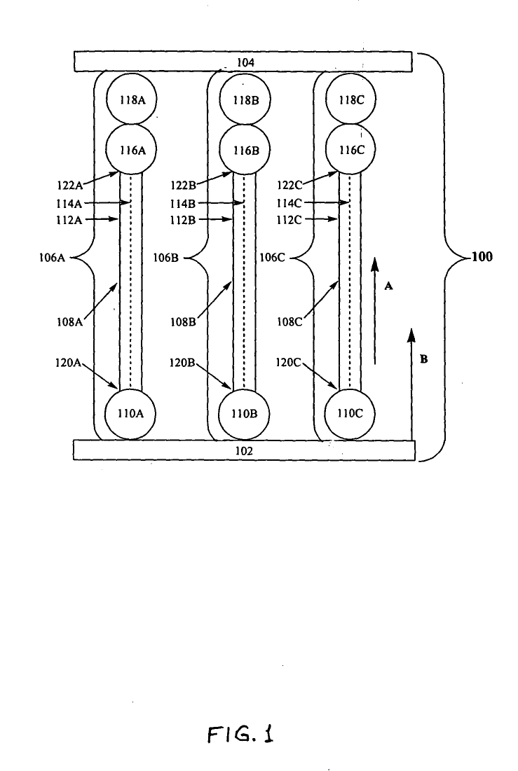

FIG. 1 illustrates a side sectional view of an organic light emitting device 100 in accordance with an embodiment of the invention. The organic light emitting device 100 can be incorporated in a display device, such as, for example, an image display device.

The organic light emitting device 100 includes a first conductive layer 102 and a second conductive layer 104. In the illustrated embodiment, the first conductive layer 102 can be configured as an anode layer, while the second conductive layer 104 can be configured as a cathode layer. Typically, at least one of the first conductive layer 102 and the second conductive layer 104 is substantially transparent or translucent. In the illustrated embodiment, the second conductive layer 104 is substantially transparent to allow emitted light to be visible through the second conductive layer 104.

As illustrated in FIG. 1, the organic light emitting device 100 also includes a set of pixel elements 106A, 106B, and 106C positioned between the first conductive layer 102 and the second conductive layer 104. While three pixel elements 106A, 106B, and 106C are illustrated in FIG. 1, it is contemplated that more or less pixel elements can be used depending on the specific application. The pixel elements 106A, 106B, and 106C are configured to emit light when a voltage is applied to the first conductive layer 102 and the second conductive layer 104. In particular, when a voltage is applied, the pixel elements 106A, 106B, and 106C are configured to provide transport of electrical energy between the first conductive layer 102 and the second conductive layer 104, and the pixel elements 106A, 106B, and 106C are configured to emit light in response to this transport of electrical energy.

In the illustrated embodiment, the pixel elements 106A, 106B, and 106C are arranged in an array between the first conductive layer 102 and the second conductive layer 104. In particular, the pixel elements 106A, 106B, and 106C are arranged in a substantially ordered array, such that the pixel elements 106A, 106B, and 106C are substantially regularly spaced apart from one another. As illustrated in FIG. 1, the pixel elements 106A, 106B, and 106C are substantially aligned with respect to a common direction indicated by arrow “A”. This common direction defines an angle with respect to a direction orthogonal to the first conductive layer 102, which direction is indicated by arrow “B”. In general, this angle can range from about 0 to about 90 degrees, such as, for example, from about 0 to about 25 degrees or from about 0 to about 10 degrees. As illustrated in FIG. 1, arrow “A” is substantially aligned with respect to arrow “B”, and, hence, the pixel elements 106A, 106B, and 106C are substantially orthogonal to the first conductive layer 102.

As illustrated in FIG. 1, the pixel element 106A includes a light emitting molecule 108A. The light emitting molecule 108A is elongated and extends between the first conductive layer 102 and the second conductive layer 104. In the illustrated embodiment, the light emitting molecule 108A includes a number of groups, including an anchoring group 110A, a charge transport group 112A, a light emissive group 116A, and a charge transfer group 118A. While four groups 110A, 112A, 116A, and 118A are illustrated in FIG. 1, it is contemplated that the light emitting molecule 108A can include more or less groups depending on the specific application.

The anchoring group 110A is configured to bond the light emitting molecule 108A to the first conductive layer 102. By bonding the light emitting molecule 108A to the first conductive layer 102, the anchoring group 110A serves to maintain the spacing and alignment of the light emitting molecule 108A with respect to an adjacent light emitting molecule. Also, the anchoring group 110A serves to facilitate transport of electrical energy between the first conductive layer 102 and the charge transport group 112A.

In the illustrated embodiment, the anchoring group 110A is configured to form a chemical bond with the first conductive layer 102. In particular, the anchoring group 10A can include an atom, such as, for example, a nitrogen atom, an oxygen atom, a silicon atom, or a sulfur atom, and this atom can be configured to form a chemical bond with the first conductive layer 102. The chemical bond can be, for example, a covalent bond, a chemisorptive bond, or a combination thereof. Examples of anchoring groups include carboxy groups, thio groups, disulfide groups, amino groups, alkylamino groups, silyl groups, and siloxy groups. In some instances, one or more atoms of the anchoring group 110A can be removed to allow bonding to the first conductive layer 102. For example, a hydrogen atom of a thio group can be removed to allow formation of a chemical bond between a sulfur atom of the thio group and the first conductive layer 102. As another example, a proton of a carboxy group can be removed to allow formation of one or more chemical bonds between oxygen atoms of the carboxy group and the first conductive layer 102.

Typically, selection of the anchoring group 110A will depend on its ability to form a chemical bond with the first conductive layer 102. For example, when the first conductive layer 102 is formed from a metal oxide such as indium tin oxide, the anchoring group 110A desirably includes an oxygen atom or a silicon atom to allow formation of a chemical bond between the oxygen atom or the silicon atom and the metal oxide. As another example, when the first conductive layer 102 is formed from a metal such as gold, the anchoring group 110A desirably includes a sulfur atom to allow formation of a chemical bond between the sulfur atom and the metal.

In some instances, the anchoring group 110A can include an atom that is configured to form multiple chemical bonds with the first conductive layer 102. For example, the anchoring group 110A can include a silicon atom that can form up to 3 chemical bonds with the first conductive layer 102. In other instances, the anchoring group 110A can include multiple atoms that can each form a chemical bond with the first conductive layer 102, which multiple atoms can be the same or different. For example, the anchoring group 110A can include multiple oxygen atoms or multiple sulfur atoms that can each form a chemical bond with the first conductive layer 102.

As illustrated in FIG. 1, the charge transport group 112A has a first end 120A, a second end 122A, and a longitudinal axis 114A. The first end 120A of the charge transport group 112A is bonded to the anchoring group 110A. In the illustrated embodiment, the first end 120A of the charge transport group 112A is configured to form a covalent bond with the anchoring group 110A.

The charge transport group 112A is configured to provide transport of electrical energy between the anchoring group 110A and the light emissive group 116A. In the illustrated embodiment, the transport of electrical energy is substantially one-dimensional. In particular, the transport of electrical energy can occur substantially along the longitudinal axis 114A of the charge transport group 112A. As illustrated in FIG. 1, the longitudinal axis 114A of the charge transport group 112A is substantially aligned with respect to arrow “A” and arrow “B”, and, hence, the transport of electrical energy is substantially orthogonal to the first conductive layer 102.

Typically, selection of the charge transport group 112A will depend on a number of desired characteristics. For example, selection of the charge transport group 112A can depend on an electrical conductivity of the charge transport group 112A. Also, selection of the charge transport group 112A can depend on a solubility imparted by the charge transport group 112A during formation of the organic light emitting device 100 or a spacing or alignment of the light emitting molecule 108A with respect to an adjacent light emitting molecule.

In some instances, the charge transport group 112A can include a conjugated group that includes a set of conjugated π-bonds. Advantageously, the set of conjugated π-bonds serves to facilitate transport of electrical energy between the anchoring group 110A and the light emissive group 116A. Examples of groups that can be used to form a conjugated group include alkylene groups, alkenylene groups, alkynylene groups, arylene groups, and iminylene groups.

For example, the charge transport group 112A can include a conjugated group having a formula (—A—B)ₘ—A, where A is an arylene group, and B is an alkenylene group, an alkynylene group, or an iminylene group. Here, m is an integer that can be, for example, in the range of 1 to 19. In this example, the conjugated group includes m+1 arylene groups, and the m+1 arylene groups are bonded to one another to form a chain structure. For certain applications, the conjugated group desirably includes 3 to 4 arylene groups. Each successive pair of arylene groups of the chain structure is bonded to one another via an alkenylene group, an alkynylene group, or an iminylene group. Advantageously, the chain structure can be substantially linear and can define the longitudinal axis 114A.

In some instances, a conjugated group can be formed from one or more branched or substituted groups to provide a desired spacing or alignment of the light emitting molecule 108A with respect to an adjacent light emitting molecule. For example, a substitution group such as an alkyl group can serve to increase spacing of the light emitting molecule 108A with respect to an adjacent light emitting molecule. Such increased spacing can be desirable to prevent or reduce electrical coupling between the light emitting molecule 108A and an adjacent light emitting molecule. It is also contemplated that a conjugated group can be formed from one or more branched or substituted groups to provide a desired level of solubility during formation of the organic light emitting device 100. It is further contemplated that a conjugated group can be formed from one or more branched or substituted groups to provide a desired level of electrical conductivity of the light emitting molecule 108A. For example, a substitution group such as an electron accepting group or an electron donating group can affect density of charged species along the conjugated group and can be selected to provide the desired level of electrical conductivity. In some instances, an electron donating group can increase density of charged species along the conjugated group and can serve to increase electrical conductivity of the conjugated group.

As illustrated in FIG. 1, the light emissive group 116A is bonded to the second end 122A of the charge transport group 112A. In the illustrated embodiment, the light emissive group 116A is configured to form a covalent bond with the second end 122A of the charge transport group 112A.

The light emissive group 116A is configured to emit light in response to transport of electrical energy by the charge transport group 112A. In the illustrated embodiment, the light emissive group 116A is configured to emit light having a particular wavelength or range of wavelengths. In particular, the light emissive group 116A can include a luminescer, and the luminescer can be configured to emit light having a particular wavelength or range of wavelengths.

Typically, selection of the light emissive group 116A will depend on a particular wavelength or range of wavelengths of light that is emitted. For example, when the organic light emitting device 100 is incorporated in a display device, the light emissive group 116A desirably includes a luminescer that is configured to emit light in the visible range. In particular, the luminescer can be a lanthanide metal ion that is configured to emit light in the range of 410 nm to 650 nm. For example, Eu³⁺, Dy³⁺, and Tb³⁺ are typically configured to emit light having a red color, a blue color, and a green color, respectively.

In some instances, the light emissive group 116A can include a ligand that is configured to bond to a luminescer. In particular, the ligand can bond to the luminescer to form a ligand-luminescer complex. The ligand can include a set of coordination atoms configured to form coordination bonds with the luminescer. In some instances, the ligand can encage the luminescer within a cavity or other bonding site formed by the ligand. By encaging the luminescer, the ligand can serve to protect the luminescer from deactivating conditions during formation of the organic light emitting device 100 or during end use. Also, the ligand can facilitate emission of light by the luminescer via an absorption-energy transfer-emission mechanism.

As illustrated in FIG. 1, the charge transfer group 118A is bonded to the light emissive group 116A. In the illustrated embodiment, the charge transfer group 118A is configured to form a covalent bond with the light emissive group 116A.

In addition, the charge transfer group 118A is configured to bond the light emitting molecule 108A to the second conductive layer 104. By bonding the light emitting molecule 108A to the second conductive layer 104, the charge transfer group 118A serves to maintain the spacing and alignment of the light emitting molecule 108A with respect to an adjacent light emitting molecule. Also, the charge transfer group 118A serves to facilitate transport of electrical energy between the second conductive layer 104 and the light emissive group 116A.

In some instances, the charge transfer group 118A can have a configuration that is similar to that of the anchoring group 110A. Thus, for example, the charge transfer group 118A can include an atom that is configured to form a chemical bond with the second conductive layer 104. The chemical bond can be, for example, a covalent bond, a chemisorptive bond, or a combination thereof. In other instances, the charge transfer group 118A can be configured to bond the light emitting molecule 108A to the second conductive layer 104 using a number of other mechanisms. For example, the charge transfer group 118A can be bonded to the second conductive layer 104 via any mechanical, physical, or electrical coupling that is adequate to facilitate transport of electrical energy between the second conductive layer 104 and the light emissive group 116A.

In the illustrated embodiment, the pixel elements 106B and 106C have configurations that are similar to that of the pixel element 106A. Thus, as illustrated in FIG. 1, the pixel element 106B includes a light emitting molecule 108B that is elongated and extends between the first conductive layer 102 and the second conductive layer 104. The light emitting molecule 108B includes an anchoring group 110B, a charge transport group 112B, a light emissive group 116B, and a charge transfer group 118B. The charge transport group 112B has a first end 120B, a second end 122B, and a longitudinal axis 114B. Similarly, the pixel element 106C includes a light emitting molecule 108C that is elongated and extends between the first conductive layer 102 and the second conductive layer 104. The light emitting molecule 108C includes an anchoring group 110C, a charge transport group 112C, a light emissive group 116C, and a charge transfer group 118C. The charge transport group 112C has a first end 120C, a second end 122C, and a longitudinal axis 114C.

The configuration of the organic light emitting device 100 can offer a number of advantages, such as, for example, improved transport of electrical energy, improved robustness and thermal stability, improved visual characteristics, reduced energy requirements, and reduced weight. In the illustrated embodiment, the pixel elements 106A, 106B, and 106C are formed as a monolayer of the light emitting molecules 108A, 108B, and 108C, and the light emitting molecules 108A, 108B, and 108C are arranged in a substantially ordered array. When a voltage is applied to the first conductive layer 102 and the second conductive layer 104, the light emitting molecules 108A, 108B, and 108C can provide transport of electrical energy substantially along the common direction indicated by arrow “A”. In particular, the light emitting molecules 108A, 108B, and 108C can provide substantially one-dimensional electrical pathways for charged species (e.g., electrons) as they travel from the first conductive layer 102 to the second conductive layer 104.

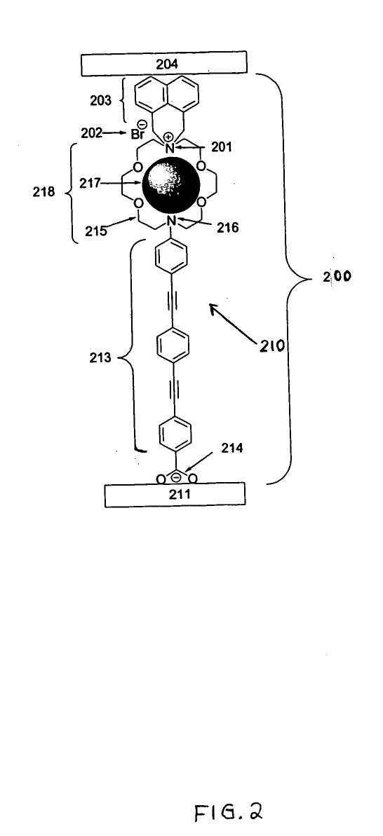

Attention next turns to FIG. 2, which illustrates a pixel element 200 in accordance with an embodiment of the invention. As illustrated in FIG. 2, the pixel element 200 includes a light emitting molecule 210. The light emitting molecule 210 is elongated and extends between a first conductive layer 211 and a second conductive layer 204. In the illustrated embodiment, the light emitting molecule 210 includes a number of groups, including an anchoring group 214, a charge transport group 213, a light emissive group 218, and a charge transfer group 203.

The anchoring group 214 is bonded to the first conductive layer 211, which can be configured as an anode layer. When a voltage is applied to the first conductive layer 211 and the second conductive layer 204, the anchoring group 214 can facilitate transport of charged species from the first conductive layer 211 to the charge transfer group 213.

In the illustrated embodiment, the anchoring group 214 is a negatively charged carboxy group. In particular, a proton of the carboxy group is removed to allow formation of two chemical bonds between oxygen atoms of the carboxy group and the first conductive layer 211. As illustrated in FIG. 2, bonding of the two oxygen atoms to the first conductive layer 211 is substantially symmetrical, such that the light emitting molecule 210 is substantially orthogonal to the first conductive layer 211. However, depending on the characteristics of the first conductive layer 211, bonding of the two oxygen atoms to the first conductive layer 211 can be asymmetrical, such that the light emitting molecule 210 can be tilted at an angle with respect to a direction orthogonal to the first conductive layer 211.

The charge transport group 213 is bonded to the anchoring group 214 and extends upwardly from the anchoring group 214. When a voltage is applied to the first conductive layer 211 and the second conductive layer 204, the charge transport group 213 can facilitate transport of charged species from the anchoring group 214 to the light emissive group 218. In particular, the charge transport group 213 can serve to provide a substantially one-dimensional electrical pathway for the charged species as they travel from the anchoring group 214 to the light emissive group 218.

In the illustrated embodiment, the charge transport group 213 is a triphenylene diethynylene. Advantageously, the triphenylenediethynylene includes a set of conjugated π-bonds that substantially extend through a length of the triphenylenediethynylene. The triphenylenediethynylene includes three phenylenes bonded to one another to form a chain structure, and each successive pair of phenylenes of the chain structure is bonded to one another via an ethynylene. The phenylenes can serve as stiffeners to maintain the spacing and alignment of the light emitting molecule 210 with respect to an adjacent light emitting molecule. The ethynylenes can serve to reduce or prevent steric interference between hydrogen atoms of adjacent phenylenes. Accordingly, the ethynylenes can serve to reduce or prevent distortions that can lead to the formation of non-conjugated portions. While three phenylenes and two ethynylenes are illustrated in FIG. 2, it is contemplated that the charge transport group 213 can include more or less groups depending on the specific application. Also, while the triphenylenediethynylene illustrated in FIG. 2 includes phenylenes that are bonded to ethynylenes in a para configuration, it is contemplated that one or more phenylenes can be bonded to ethynylenes in other configurations, such as, for example, an ortho configuration or a meta configuration.

As illustrated in FIG. 2, the light emissive group 218 is bonded to the charge transport group 213 via a nitrogen atom 216. When a voltage is applied to the first conductive layer 211 and the second conductive layer 204, the light emissive group 218 can emit light in response to transport of charged species towards the light emissive group 218.

In the illustrated embodiment, the light emissive group 218 includes a lanthanide metal ion 217, namely Eu³⁺. Eu³⁺ is typically configured to emit light having a red color. As illustrated in FIG. 2, the light emissive group 218 also includes a ligand 215 that bonds to the Eu³⁺ to form a ligand-Eu³⁺ complex. In the illustrated embodiment, the ligand 215 is a positively charged, trivalent form of a 4,13-diaza-18-crown-6. Advantageously, the ligand 215 encages the Eu³⁺ within a cavity formed by the ligand 215. By encaging the Eu³⁺, the ligand 215 can protect the Eu³⁺ from deactivating conditions during formation of the pixel element 200 or during end use. Also, the ligand 215 can facilitate emission of light by the Eu³⁺ via an absorption-energy transfer-emission mechanism. In particular, transport of charged species by the charge transport group 213 can cause emission of light outside the visible range. In particular, one or more phenylene groups forming the charge transport group 213 can emit light in the ultraviolet range in response to the transport of charged species. The ligand 215 can absorb emitted light in the ultraviolet range and can transfer energy to the Eu³⁺, which can then emit light having a red color.

The charge transfer group 203 is bonded to the light emissive group 218 via a positively charged nitrogen atom 201. As illustrated in FIG. 2, a negatively charged bromine atom 202 is positioned adjacent to the positively charged nitrogen atom 201 and can serve as a counter ion. The charge transfer group 203 is also bonded to the second conductive layer 204, which can be configured as a cathode layer. When a voltage is applied to the first conductive layer 211 and the second conductive layer 204, the charge transfer group 203 can facilitate transport of charged species from the light emissive group 218 to the second conductive layer 204. In the illustrated embodiment, the positively charged nitrogen atom 201 can serve as an electron accepting group and can facilitate transport of charged species towards the second conductive layer 204.

In the illustrated embodiment, the charge transfer group 203 is a bivalent form of a 1,8-dimethylnaphthalene. Advantageously, the charge transfer group 203 can facilitate emission of light by the Eu³⁺ via an absorption-energy transfer-emission mechanism. As discussed previously, transport of charged species by the charge transport group 213 can cause emission of light outside the visible range. The charge transfer group 203 can absorb emitted light in the ultraviolet range and can transfer energy to the Eu³⁺, which can then emit light having a red color.

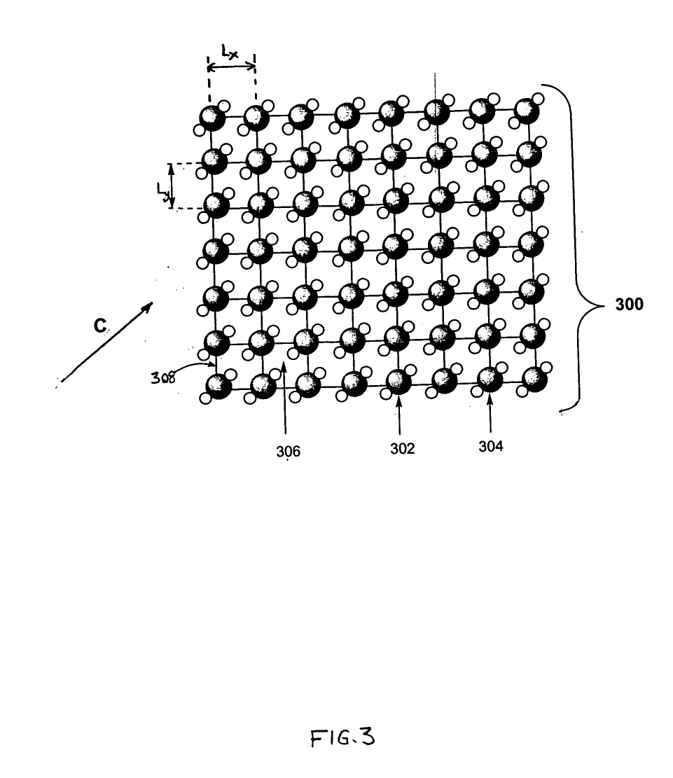

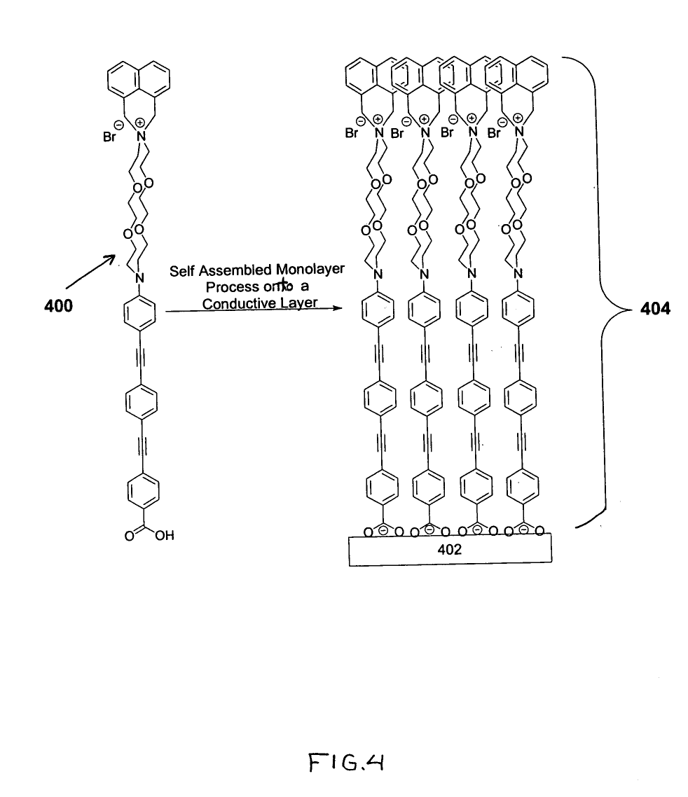

FIG. 3 illustrates a top sectional view of an organic light emitting device 300 in accordance with an embodiment of the invention. In particular, FIG. 3 illustrates various anchoring groups (e.g., anchoring groups 302 and 304) of a set of pixel elements. The anchoring groups are positioned on a surface 306 of a conductive layer 308, which can be configured as an anode layer.

In the illustrated embodiment, the anchoring groups are carboxy groups. Each carboxy group includes a carbon atom (shown shaded in FIG. 3) and a pair of oxygen atoms (shown unshaded in FIG. 3). Protons of the carboxy groups can be removed to allow formation of chemical bonds between oxygen atoms of the carboxy groups and the conductive layer 308.

As illustrated in FIG. 3, the anchoring groups are arranged in an array on the surface 306 of the conductive layer 308. In particular, the anchoring groups are arranged in a substantially ordered array, such that the anchoring groups are substantially regularly spaced apart from one another. As illustrated in FIG. 3, the carbon atoms of the anchoring groups are substantially positioned at intersection points of an imaginary rectangular lattice, and the oxygen atoms of the anchoring groups are substantially aligned with respect to a common direction indicated by arrow “C”. The rectangular lattice can be characterized by lattice spacings Lₓ and L_{y}, which can be the same or different. In the illustrated embodiment, the lattice spacings Lₓ and L_{y} can each be in the range of about 0.1 nm to about 10 nm, such as, for example, from about 0.1 nm to about 1 nm.

Depending on the particular application, the spacing and alignment of the anchoring groups can be varied from that illustrated in FIG. 3. For example, it is contemplated that the anchoring groups can be positioned at intersection points of various other types of 2-dimensional lattices, such as hexagonal lattices and centered lattices. As another example, it is contemplated that the anchoring groups can be randomly positioned on the surface 306 or can be concentrated in one or more portions of the surface 306. As a further example, it is contemplated that the anchoring groups can be randomly aligned or can be aligned with respect to two or more different directions.

### Methods of Forming Organic Light Emitting Devices

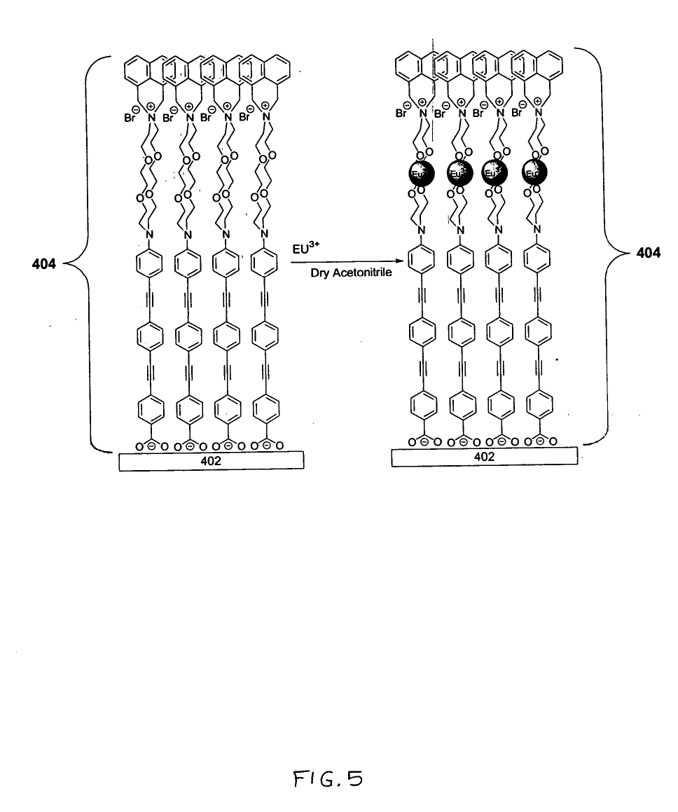

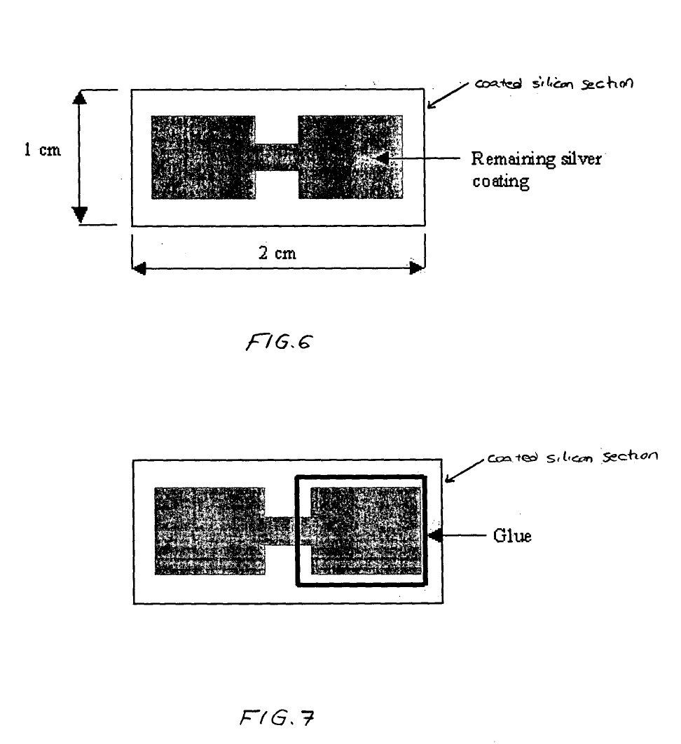

Organic light emitting devices in accordance with various embodiments of the invention can be formed using various methods. FIG. 4 and FIG. 5 illustrate a method of forming an organic light emitting device using a self-assembled monolayer process, according to an embodiment of the invention. Referring to FIG. 4, light emitting molecules (e.g., light emitting molecule 400) are initially formed without luminescers. Once formed, the light emitting molecules are then dispersed in a solvent to form a solution. As a result of the characteristics of anchoring groups of the light emitting molecules, the light emitting molecules can spontaneously align with respect to a common direction that is substantially orthogonal to a surface of the solution. The light emitting molecules are then transferred to a conductive layer 402 by contacting the conductive layer 402 with the solution. The light emitting molecules can bond to the conductive layer 402 to form a self-assembled monolayer 404 on the conductive layer 402.

Referring to FIG. 5, luminescers are next added to the self-assembled monolayer 404. In particular, the self-assembled monolayer 404 is first treated by, for example, rinsing with dry acetonitrile and drying with a stream of dried nitrogen. Next, the self-assembled monolayer 404 is contacted with a solution of the luminescers. In particular, the self-assembled monolayer 404 is placed in a solution of Eu³⁺ in dry acetonitrile to allow the Eu³⁺ to bond to the light emitting molecules. Another conductive layer can then be formed above the self-assembled monolayer 404 to form the organic light emitting device.

### EXAMPLES

The following examples are provided as a guide for a practitioner of ordinary skill in the art. The examples should not be construed as limiting the invention, as the examples merely provide specific methodology useful in understanding and practicing some embodiments of the invention.

### Example 1

### Formation of Light Emitting Molecules

Formation of ((4-bromophenyl)ethynyl)trimethylsilane (Formula 3):

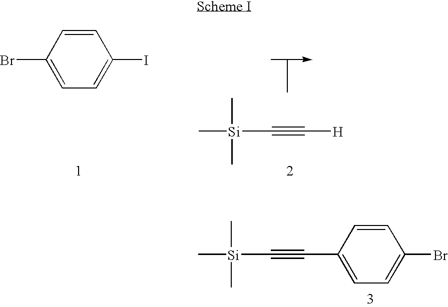

A solution of 1-bromo-4-iodobenzene (Formula 1, 1.99 g, 7.070 mmol), trimethylsilylacetylene (Formula 2, 0.72 g, 7.070 mmol), copper(I)iodide (0.076 g, 0.388 mmol) and dichlorobis(triphenylphosphine)palladium(II) (PdCl₂(PPh₃)₂, 0.088 g, 0.126 mmol) in diethylamine (20.00 ml) was heated at 38° C. for 12 h under an atmosphere of dry nitrogen. The solution was cooled to room temperature, washed with water, and extracted using hexane (3×30 ml). The combined extracts were washed with brine and dried (Na₂SO₄), and the solvent was removed in vacuo to yield a yellow solid. The yellow solid was purified by column chromatography (silica gel eluted with hexane) to yield a solid that was recrystallized from ethanol to yield white crystals. Yield: 1.67 g, 93%. H¹ nmr (CDCl₃) δ; 0.08 (9H, s), 7.31 (2H, d), and 7.40 (2H, d).

Formation of 4-(4-trimethylsilylethynylphenyl)-4,13-diaza-18-crown-6 (Formula 5):

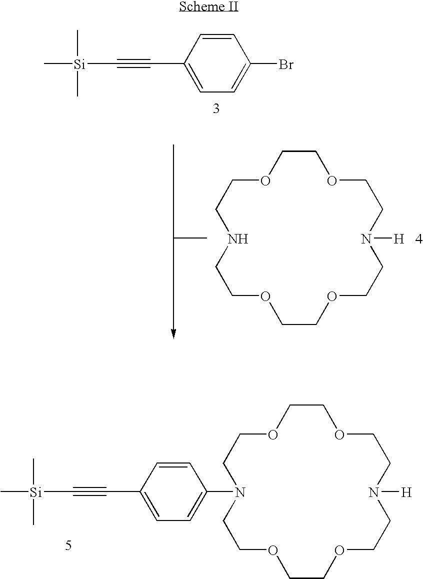

A solution of ((4-bromophenyl)ethynyl)trimethylsilane (Formula 3, 1.26 g, 5.00 mmol), 4,13-diaza-18-crown-6 (Formula 4, 1.26 g, 5.00 mmol), sodium carbonate (1.06 g, 10.00 mmol), t-butylammonium iodide (TBAI, 0.063 g, 0.250 mmol), and tetrakis(triphenylphosphine) palladium(0) (Pd(PPh₃)₄, 0.115 g, 0.100 mmol) in dimethylsulfoxide (DMSO) was heated at 100° C. for 12 h under an atmosphere of dry nitrogen. The solution was cooled to room temperature, washed with water, and extracted using diethyl ether (3×40 ml). The combined extracts were washed with brine and dried (Na₂SO₄), and the solvent was removed in vacuo to yield a solid. The solid was purified by column chromatography (silica gel eluted with hexane/ethyl acetate (4:1)) to yield a solid that was recrystallized from ethanol to yield white crystals. Yield: 1.22 g, 56%. H¹ nmr (CDCl₃) δ; 0.08 (9H, s), 2.00 (1H, s), 2.72 (4H, d of t), 3.49 (4H, d of t), 3.52 (4H, d oft), 3.54 (4H, d oft), 3.60 (4H, d oft), 6.56 (2H, d), and 7.24 (2H, d).

Formation of 4-(4-trimethylsilylethynylphenyl)-13-((4-cyanophenyl)methyl)-4,13-diaza-18-crown-6 (Formula 7):

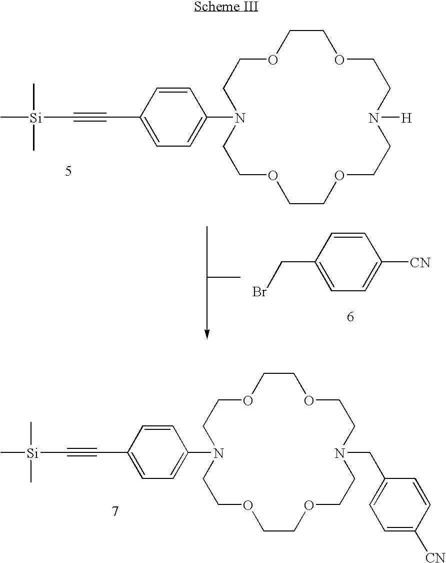

A solution of 4-(4-trimethylsilylethynylphenyl)-4,13-diaza-18-crown-6 (Formula 5, 1.20 g, 2.76 mmol) in dry tetrahydrofuran (THF, 30 ml) was added dropwise to a solution of sodium hydride (0.098 g, 3.86 mmol, 95% in oil) in dry THF (40 ml). The reaction mixture was stirred at room temperature for 30 min, and a solution of 1-bromomethyl-4-cyanobenzene (Formula 6, 0.76 g, 3.86 mmol) in dry THF (30 ml) was added dropwise. The reaction mixture was heated under reflux for 16 h under an atmosphere of dry nitrogen, cooled to room temperature, washed with water, and extracted using hexane/ethyl acetate (3×35 ml, 1:1). The combined extracts were washed with brine and dried (Na₂SO₄), and the solvent was removed in vacuo to yield a solid. The solid was purified by column chromatography (silica gel eluted with hexane/ethyl acetate (4:1)) to yield white crystals. Yield: 1.26 g, 83%. H¹ nmr (CDCl₃) δ; 0.08 (9H, s), 2.53 (4H, d of t), 3.47 (4H, d of t), 3.52 (4H, d of t), 3.54 (8H, d of t), 3.60 (4H, d oft), 3.62 (2H, s), 6.56 (2H, d), 7.24 (4H, d), and 7.39 (2H, d).

Formation of 4-(4-ethynylphenyl)-13-((4-cyanophenyl)methyl)-4,13-diaza-18-crown-6 (Formula 8):

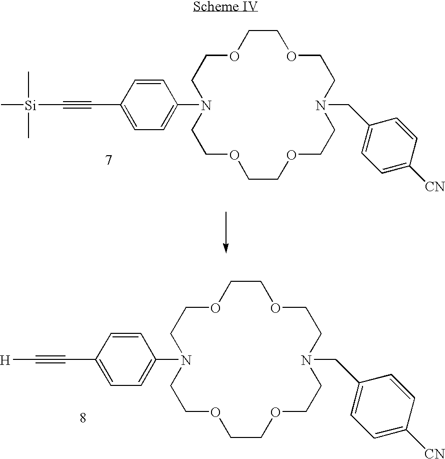

A solution of t-butylammonium fluoride (TBAF, 4.40 ml, 4.40 mmol, 1.0 M solution in THF) was added dropwise to a stirred solution of 4-(4-trimethylsilylethynylphenyl)-13-((4-cyanophenyl)methyl)-4,13-diaza-18-crown-6 (Formula 7, 1.21 g, 2.20 mmol) in dry THF (30 ml) under an atmosphere of dry nitrogen, and the reaction mixture was stirred at 22° C. for 6 h. The reaction mixture was washed with water and extracted using hexane (3×25 ml). The combined extracts were washed with brine and dried (Na₂SO₄), and the solvent was removed in vacuo to yield a solid. The solid was purified by column chromatography (silica gel eluted with hexane/ethyl acetate (4:1)) to yield a solid that was recrystallized from ethanol to yield white crystals. Yield: 0.82 g, 78%. H¹ nmr (CDCl₃) δ; 2.53 (4H, d of t), 3.06 (1H, s), 3.47 (4H, d of t), 3.52 (4H, d of t), 3.54 (8H, d of t), 3.60 (4H, d of t), 3.62 (2H, s), 6.56 (2H, d), 7.24 (4H, d), and 7.39 (2H, d).

Formation of ((4-iodophenyl)ethynyl)trimethylsilane (Formula 9):

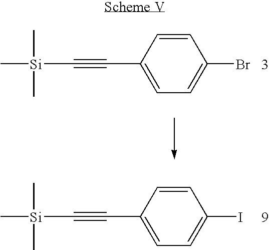

A solution of butyllithium (2.67 ml, 6.67 mmol, 2.5 M in hexane) was added dropwise to a stirred, cooled solution of ((4-bromophenyl)ethynyl)trimethylsilane (Formula 3, 1.68 g, 6.67 mmol) in dry THF (40 ml) under an atmosphere of dry nitrogen. The reaction mixture was stirred at a temperature held under −68° C. for 30 min, and a solution of iodine (2.84 g, 9.34 mmol in 20.0 ml of dry THF) was added dropwise. The reaction mixture was further stirred at −78° C. for 30 min, warmed to room temperature, washed with water, and extracted using hexane (3×45 ml). The combined extracts were washed with brine and dried (Na₂SO₄), and the solvent was removed in vacuo to yield a solid. The solid was purified by column chromatography (silica gel eluted with hexane) to yield a solid that was recrystallized from ethanol to yield white crystals. Yield: 1.46 g, 73%. H¹ nmr (CDCl₃) δ; 0.08 (9H, s), 7.19 (2H, d), and 7.61 (2H, d).

Formation of 4-(4-(4-trimethylsilylethynylphenyl)ethynylphenyl)-13-((4-cyanophenyl)methyl)-4,13-diaza-18-crown-6 (Formula 10):

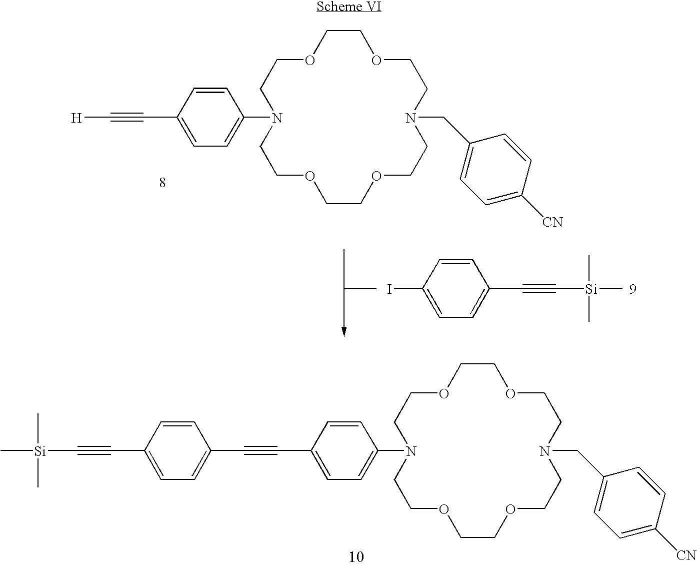

A solution of 4-(4-ethynylphenyl)-13-((4-cyanophenyl)methyl)-4,13-diaza-18-crown-6 (Formula 8, 0.76 g, 1.60 mmol), ((4-iodophenyl)ethynyl)trimethylsilane (Formula 9, 0.48 g, 1.60 mmol), copper(I)iodide (0.017 g, 0.088 mmol), and PdCl₂(PPh₃)₂ (0.020 g, 0.029 mmol) in diethylamine (40.00 ml) was processed as described for Scheme I to yield white crystals. Yield: 0.96 g, 92%. H¹ nmr (CDCl₃) δ; 0.08 (9H, s), 2.53 (4H, d of t), 3.47 (4H, d of t), 3.52 (4H, d of t), 3.54 (8H, d of t), 3.60 (4H, d of t), 3.62 (2H, s), 6.55 (2H, d), 7.24 (2H, d), 7.28 (2H, d), 7.38 (2H, d), 7.39 (2H, d), and 7.43 (2H, d).

Formation of 4-(4-(4-ethynylphenyl)ethynylphenyl)-13-((4-cyanophenyl)methyl)-4,13-diaza-18-crown-6 (Formula 11):

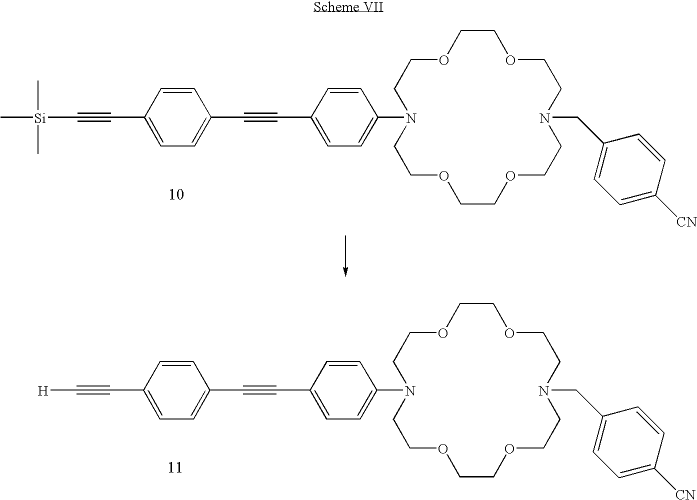

A solution of TBAF (2.80 ml, 2.80 mmol, 1.0 M solution in THF) was added dropwise to a stirred solution of 4-(4-(4-trimethylsilylethynylphenyl)ethynylphenyl)-13-((4-cyanophenyl)methyl)-4,13-diaza-18-crown-6 (Formula 10, 0.910 g, 1.40 mmol), and the reaction mixture was processed as described for Scheme IV to yield white crystals. Yield: 0.72 g, 89%. H¹ nmr (CDCl₃) δ; 2.53 (4H, d of t), 3.06 (1H, s), 3.47 (4H, d of t), 3.52 (4H, d of t), 3.54 (8H, d oft), 3.60 (4H, d oft), 3.62 (2H, s), 6.55 (2H, d), 7.24 (2H, d), 7.28 (2H, d), 7.38 (2H, d), 7.39 (2H, d), and 7.43 (2H, d).

Formation of 1-iodo-4-trimethylsiloxycarbonyl-benzene (Formula 13):

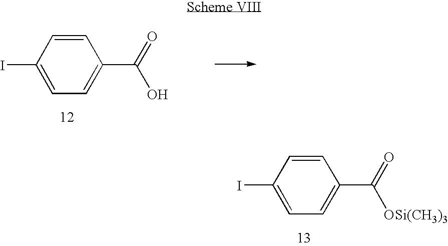

Chlorotrimethylsilane (0.44 g, 4.03 mmol) was added dropwise to a stirred, cooled (0° C.) solution of 4-iodobenzoic acid (Formula 12, 1.00 g, 4.03 mmol) and pyridine (0.35 g, 4.43 mmol) in THF (40 ml), and the reaction mixture was stirred for 30 min under an atmosphere of dry nitrogen. The solvent was removed in vacuo, and a crude product was purified by column chromatography (silica gel eluted with hexane) to yield white crystals. Yield: 1.05 g, 81%. H¹ (CDCl₃) δ; 0.08 (9H, s), 7.85 (2H, d), and 7.90 (2H, d).

Formation of 4-(4-(4-(4-trimethylsiloxycarbonylphenyl)ethynylphenyl)ethynylphenyl)-13-((4-cyanophenyl)methyl)-4,13-diaza-18-crown-6 (Formula 14):

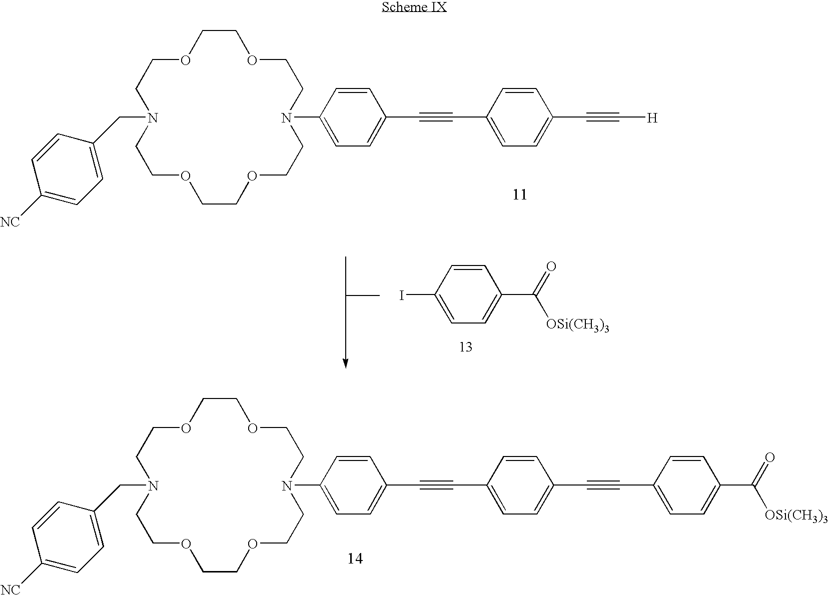

A solution of 4-(4-(4-ethynylphenyl)ethynylphenyl)-13-((4-cyanophenyl) methyl)-4,13-diaza-18-crown-6 (Formula 11, 0.70 g, 1.21 mmol), 1-iodo-4-trimethylsiloxy carbonyl-benzene (Formula 13, 0.39 g, 1.21 mmol), copper(I)iodide (0.013 g, 0.007 mmol), PdCl₂(PPh₃)₂ (0.015 g, 0.022 mmol) in diethylamine (30.00 ml) was processed as described for Scheme I to yield white crystals. Yield: 0.86 g, 92%. H¹ nmr (CDCl₃) δ; 0.08 (9H, s), 2.53 (4H, d of t), 3.47 (4H, d of t), 3.52 (4H, d of t), 3.54 (8H, d of t), 3.60 (4H, d of t), 3.62 (2H, s), 6.55 (2H, d), 7.24 (2H, d), 7.28 (2H, d), 7.38 (2H, d), 7.39 (2H, d), 7.43 (2H, d), 7.67 (2H, d), and 8.09 (2H, d).

Formation of 4-(4-(4-(4-carboxyphenyl)ethynylphenyl)ethynylphenyl)-13-((4-cyanophenyl) methyl)-4,13-diaza-18-crown-6 (Formula 15):

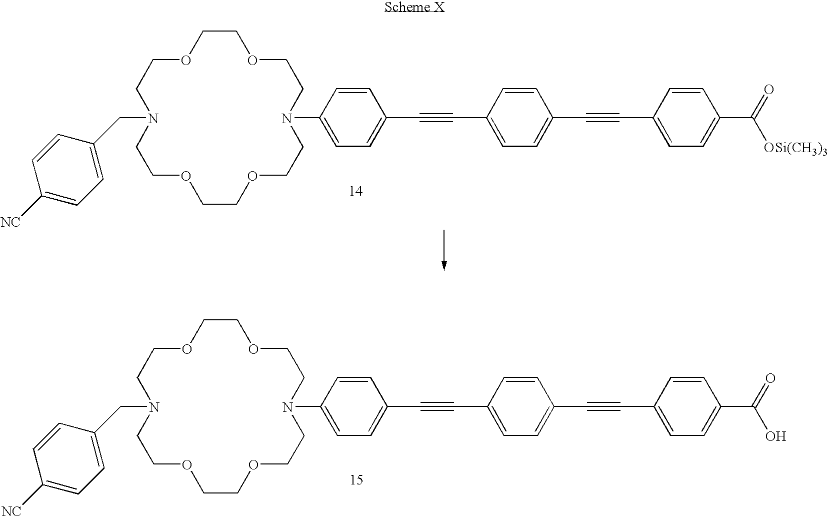

A solution of 4-(4-(4-(4-trimethylsiloxycarbonylphenyl)ethynylphenyl)ethynyl phenyl)-13-((4-cyanophenyl)methyl)-4,13-diaza-18-crown-6 (Formula 14, 0.85 g, 1.10 mmol) and potassium fluoride (0.13 g, 2.20 mmol in 20 ml of water) in ethanol was stirred at room temperature for 1 h. The solution was washed with water and extracted using hexane/ethyl acetate (3×40 ml, 1:1). The combined extracts were dried (Na₂SO₄), and the solvent was removed in vacuo. A crude product was recrystallized from ethanol/acetonitrile (1:1) to yield white crystals. Yield: 0.68 g, 89%. H¹ nmr (DMSO) δ; 2.53 (4H, d of t), 3.47 (4H, d of t), 3.52 (4H, d of t), 3.54 (8H, d of t), 3.60 (4H, d of t), 3.62 (2H, s), 6.55 (2H, d), 7.24 (2H, d), 7.28 (2H, d), 7.38 (2H, d), 7.39 (2H, d), 7.43 (2H, d), 7.67 (2H, d), 8.09 (2H, d), and 11.01 (1H, broad s —OH).

### Example 2

### Formation of Organic Light Emitting Device

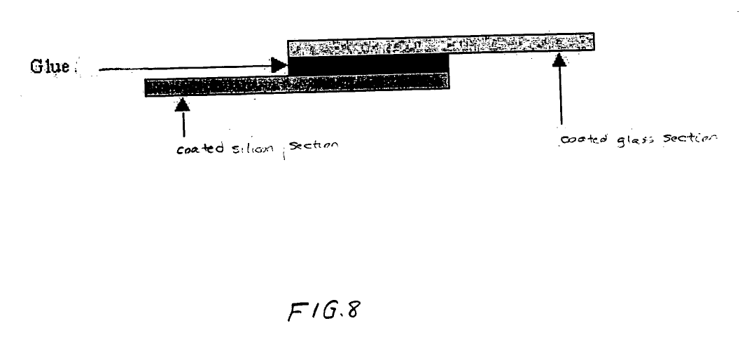

FIG. 6, FIG. 7, and FIG. 8 illustrate an example of forming an organic light emitting device using a self-assembled monolayer process. A 4-inch, highly-doped silicon wafer is coated by vapor deposition. In particular, the silicon wafer is initially coated with chromium to a thickness in the range of 8 nm to 12 nm and is then coated with silver (99.99%) to a thickness in the range of 70 nm to 100 nm. The coated silicon wafer is then diced to form a 1 cm×2 cm coated silicon section, which is washed with dry ethanol and dried with a stream of dry nitrogen. The coated silicon section is then patterned by O₂-plasma etching in conjunction with a shadow mask as illustrated in FIG. 6. Once patterned, the coated silicon section is further cleaned in an ethanol/ultrasonic bath and dried with a stream of dry nitrogen.

Next, the coated silicon section is immersed in a solution of light emitting molecules (Formula 15, 2.5×10⁻⁴ mol in dry THF, toluene, and acetonitrile (1:1:1)) under an atmosphere of dry nitrogen for 16 hours at 22° C. The light emitting molecules bond to the coated silicon section to form a self-assembled monolayer on the coated silicon section. The coated silicon section with the self-assembled monolayer is washed with dry ethanol and dried with a stream of dry nitrogen.

The coated silicon section with the self-assembled monolayer is placed in a nitrogen purged vessel and is partially immersed (1 cm depth) in a solution of europium acetate in dry acetonitrile at a temperature in the range of about 50° C. to about 55° C. The solution is maintained at that temperature for about 30 minutes to about 2 hours with gentle stirring. The solution is then removed under an inert atmosphere, and the coated silicon section with the self-assembled monolayer is rinsed with dry acetonitrile and dried with a stream of dry nitrogen.

A 8-inch glass substrate with a layer of indium tin oxide is spin-coated with an electrically conductive polymeric material on the indium tin oxide side. Next, the coated glass substrate is dried with a stream of dry nitrogen. The coated glass substrate is then diced to form a 1 cm×2 cm coated glass section, which is washed with dry ethanol and dried with a stream of dry nitrogen.

A thin line of glue is deposited on the coated silicon section on the self-assembled monolayer side as illustrated in FIG. 7. As illustrated in FIG. 8, the coated glass section is positioned over the coated silicon section to form a laminate, such that the laminate provides two electrical contact points. Once the coated glass section is thus positioned, pressure is applied evenly, and the glue is cured. The electrically conductive polymeric material is bonded to the self-assembled monolayer.

Each of the patent applications, patents, publications, and other published documents mentioned or referred to in this specification is herein incorporated by reference in its entirety, to the same extent as if each individual patent application, patent, publication, and other published document was specifically and individually indicated to be incorporated by reference.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process step or steps, to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. A light emitting molecule, comprising:
an anchoring group;
a charge transport group having a first end and a second end, said first end of said charge transport group being bonded to said anchoring group, said charge transport group being configured to provide transport of electrical energy, said transport of electrical energy being substantially one-dimensional;
a light emissive group bonded to said second end of said charge transport group; and
a charge transfer group bonded to said light emissive group.

2. The light emitting molecule of claim 1, wherein said anchoring group includes an atom configured to form a chemical bond with an anode layer, said chemical bond being one of a covalent bond and a chemisorptive bond.

3. The light emitting molecule of claim 1, wherein said charge transport group has a longitudinal axis, said transport of electrical energy being substantially along said longitudinal axis.

4. The light emitting molecule of claim 1, wherein said charge transport group includes a conjugated group, said conjugated group including a plurality of conjugated π-bonds.

5. The light emitting molecule of claim 4, wherein said conjugated group includes at least one arylene group.

6. The light emitting molecule of claim 5, wherein said conjugated group includes at least two arylene groups bonded to one another to form a chain structure.

7. The light emitting molecule of claim 1, wherein said light emissive group includes a lanthanide metal ion.

8. The light emitting molecule of claim 7, wherein said lanthanide metal ion is one of Eu³⁺, Dy³⁺, and Tb³⁺.

9. The light emitting molecule of claim 7, wherein said light emissive group further includes a ligand, said lanthanide metal ion being encaged within said ligand.

10. The light emitting molecule of claim 1, wherein said charge transfer group includes an electron accepting group.

11. A pixel element, comprising:
a light emitting molecule including
an anchoring group,
a conjugated group extending from said anchoring group and having a first end bonded to said anchoring group and an opposite, second end, said conjugated group having a formula (-A-B)ₘ-A, m being an integer in the range of 1 to 19, A being an arylene group, B being one of an alkenylene group, an alkynylene group, and an iminylene group, and
a light emissive group bonded to said second end of said conjugated group.

12. The pixel element of claim 11, wherein said anchoring group is configured to bond said light emitting molecule to an anode layer.

13. The pixel element of claim 12, wherein said anchoring group includes an atom configured to form a chemical bond with said anode layer, said atom being one of a nitrogen atom, an oxygen atom, a silicon atom, and a sulfur atom.

14. The pixel element of claim 11, wherein said conjugated group is configured to provide transport of electrical energy from said anchoring group to said light emissive group, said transport of electrical energy being substantially one-dimensional.

15. The pixel element of claim 11, wherein A is one of phenylene, pyridinylene, and pyrimidinylene.

16. The pixel element of claim 11, wherein B is ethynylene.

17. The pixel element of claim 11, wherein said light emissive group includes a luminescer.

18. The pixel element of claim 17, wherein said luminescer is a lanthanide metal ion.

19. The pixel element of claim 11, wherein said light emissive group includes a ligand-luminescer complex.

20. The pixel element of claim 11, wherein said light emitting molecule further includes a charge transfer group bonded to said light emissive group and configured to bond said light emitting molecule to a cathode layer.

21. An organic light emitting device, comprising:
a plurality of pixel elements arranged in an array, at least one pixel element of said plurality of pixel elements including a light emitting molecule that includes
an anchoring group configured to bond said light emitting molecule to a first conductive layer,
a charge transport group having a first end, a second end, and a longitudinal axis, said first end of said charge transport group being bonded to said anchoring group, said charge transport group being configured to provide transport of electrical energy substantially along said longitudinal axis,
a light emissive group bonded to said second end of said charge transport group, and
a charge transfer group bonded to said light emissive group and configured to bond said light emitting molecule to a second conductive layer.

22. The organic light emitting device of claim 21, wherein said plurality of pixel elements are substantially aligned with respect to a common direction.

23. The organic light emitting device of claim 21, wherein said anchoring group includes one of a nitrogen atom, an oxygen atom, a silicon atom, and a sulfur atom.

24. The organic light emitting device of claim 21, wherein said longitudinal axis of said charge transport group extends between said first end of said charge transport group and said second end of said charge transport group.

25. The organic light emitting device of claim 21, wherein said charge transport group includes a plurality of conjugated π-bonds.

26. The organic light emitting device of claim 21, wherein said charge transport group includes at least one of an alkenylene group, an alkynylene group, an arylene group, and an iminylene group.

27. The organic light emitting device of claim 21, wherein said charge transport group includes a conjugated group having a formula:
(-A-B)ₘ-A,
wherein m is an integer in the range of 1 to 19, A is an arylene group, and B is one of an alkenylene group, an alkynylene group, and an iminylene group.

28. The organic light emitting device of claim 21, wherein said light emissive group includes a lanthanide metal ion.

29. The organic light emitting device of claim 28, wherein said light emissive group further includes a ligand encaging said lanthanide metal ion.

30. A display device, comprising:
an anode layer;
a cathode layer; and
a plurality of pixel elements arranged in an array and positioned between said anode layer and said cathode layer, at least one pixel element of said plurality of pixel elements including a light emitting molecule that includes
an anchoring group bonded to said anode layer,
a charge transport group having a first end and a second end, said first end of said charge transport group being bonded to said anchoring group,
a light emissive group bonded to said second end of said charge transport group, and
a charge transfer group bonded to said light emissive group and to said cathode layer.

31. The display device of claim 30, wherein said anchoring group forms a chemical bond with said anode layer, said chemical bond being one of a covalent bond and a chemisorptive bond.

32. The display device of claim 30, wherein said charge transport group is configured to provide transport of electrical energy substantially along a direction from said anode layer to said cathode layer.

33. The display device of claim 32, wherein said direction defines an angle with respect to a direction orthogonal to said anode layer, said angle being in the range of 0 to 25 degrees.

34. The display device of claim 32, wherein said direction is substantially orthogonal to a surface of said anode layer.

35. The display device of claim 30, wherein said charge transport group includes n arylene groups, n being an integer in the range of 2 to 20.

36. The display device of claim 35, wherein said n arylene groups are bonded to one another to form a chain structure.

37. The display device of claim 36, wherein said charge transport group further includes n−1 alkylene groups, each alkylene group of said n−1 alkylene groups being bonded to two successive arylene groups of said chain structure.

38. The display device of claim 36, wherein said charge transport group further includes n−1 alkenylene groups, each alkenylene group of said n−1 alkenylene groups being bonded to two successive arylene groups of said chain structure.

39. The display device of claim 36, wherein said charge transport group further includes n−1 alkynylene groups, each alkynylene group of said n−1 alkynylene groups being bonded to two successive arylene groups of said chain structure.

40. The display device of claim 36, wherein said charge transport group further includes n−1 iminylene groups, each iminylene group of said n−1 iminylene groups being bonded to two successive arylene groups of said chain structure.

41. The display device of claim 30, wherein said light emissive group is configured to emit light having a wavelength in the visible range.

42. The display device of claim 30, wherein said light emissive group includes a luminescer.

43. The display device of claim 42, wherein said light emissive group further includes a ligand encaging said luminescer.

44. A display device, comprising:
a first conductive layer;
a second conductive layer; and
a plurality of light emitting molecules positioned between said first conductive layer and said second conductive layer, said plurality of light emitting molecules being substantially aligned with respect to a common direction, at least one light emitting molecule of said plurality of light emitting molecules including
an anchoring group bonded to said first conductive layer,
a conjugated group extending from said anchoring group and having a first end bonded to said anchoring group and an opposite, second end, and
a light emissive group bonded to said second end of said conjugated group.

45. The display device of claim 44, wherein said common direction defines an angle with respect to a direction orthogonal to said first conductive layer, said angle being in the range of 0 to 25 degrees.

46. The display device of claim 45, wherein said angle is in the range of 0 to 10 degrees.

47. The display device of claim 44, wherein each light emitting molecule of said plurality of light emitting molecules extends between said first conductive layer and said second conductive layer.

48. The display device of claim 44, wherein said anchoring group includes an atom configured to form a chemical bond with said first conductive layer, said atom being one of a nitrogen atom, an oxygen atom, a silicon atom, and a sulfur atom.

49. The display device of claim 44, wherein each light emitting molecule of said plurality of light emitting molecules includes an anchoring group, said anchoring groups of said plurality of molecules being arranged in an array on a surface of said first conductive layer.

50. The display device of claim 44, wherein said conjugated group includes a plurality of conjugated π-bonds.

51. The display device of claim 44, wherein said conjugated group includes at least one arylene group.

52. The display device of claim 51, wherein said conjugated group includes n arylene groups, n being an integer in the range of 2 to 20.

53. The display device of claim 52, wherein said n arylene groups are bonded to one another to form a chain structure.

54. The display device of claim 53, wherein said conjugated group further includes at least one alkenylene group bonded to two successive arylene groups of said chain structure.

55. The display device of claim 54, wherein said conjugated group further includes n−1 alkenylene groups, each alkenylene group of said n−1 alkenylene groups being bonded to two successive arylene groups of said chain structure.

56. The display device of claim 53, wherein said conjugated group further includes at least one alkynylene group bonded to two successive arylene groups of said chain structure.

57. The display device of claim 56, wherein said conjugated group further includes n−1 alkynylene groups, each alkynylene group of said n−1 alkynylene groups being bonded to two successive arylene groups of said chain structure.

58. The display device of claim 53, wherein said conjugated group further includes at least one iminylene group bonded to two successive arylene groups of said chain structure.

59. The display device of claim 58, wherein said conjugated group further includes n−1 iminylene groups, each iminylene group of said n−1 iminylene groups being bonded to two successive arylene groups of said chain structure.

60. The display device of claim 44, wherein said light emissive group is configured to emit light having a wavelength in the range 410 nm to 650 nm.

61. The display device of claim 44, wherein said light emissive group includes a metal ion.

62. The display device of claim 61, wherein said metal ion is a lanthanide metal ion.

63. The display device of claim 62, wherein said lanthanide metal ion is one of Eu³⁺, Dy³⁺, and Tb³⁺.

64. The display device of claim 62, wherein said light emissive group further includes a ligand, said lanthanide metal ion being encaged within said ligand.

65. The display device of claim 44, wherein said at least one molecule further includes a charge transfer group bonded to said light emissive group and to said second conductive layer.
